(19) United States
(12) Patent Application Publication
(10) Pub. No.: US 2013/0123389 A1
(43) Pub. Date: May 16, 2013

(54) COMPOSITIONS AND PROCESSES FOR PRODUCING DURABLE HYDROPHOBIC AND/OR OLEPHOBIC SURFACES

(71) Applicants: Jingxu ZHU, London (CA); Hui ZHANG, London (CA)

(72) Inventors: Jingxu ZHU, London (CA); Hui ZHANG, London (CA)

(21) Appl. No.: 13/737,770

(22) Filed: Jan. 9, 2013

Related U.S. Application Data
(63) Continuation of application No. 12/216,309, filed on Jul. 2, 2008, now abandoned.

(51) Int. Cl. C09D 5/00; B05D 3/00

(52) U.S. Cl. CPC C09D 5/00; B05D 3/00
USPC 523/400; 427/372.2; 524/560

(57) ABSTRACT

A method for forming a coating composition for application to a surface. The method includes forming conglomerates by providing a plurality of nano-sized particles having a mean diameter in a range from about 1 to about 500 nanometers, the nano-sized particles having hydrophobic, super-hydrophobic, olephobic, or super-olephobic properties; mixing the plurality of nano-sized particles with a binding material to form a mixture and heating the mixture to induce curing to bind the nano-sized particles to form a consolidated cake-form material; cooling the consolidated cake-form material and grinding the cake-form material to produce conglomerates having a size in a range from about 1 micron to about 40 microns; and b) mixing the conglomerates with a coating material to be applied to a surface, the binding material being one of a thermosetting resin and a thermoplastic resin having a melting temperature higher than a curing temperature of the coating composition.

### CROSS REFERENCE TO RELATED U.S. APPLICATION

This application is a continuation application of U.S. Ser. No. 12/216,309 filed on Jul. 2, 2008, in English, titled COMPOSITIONS AND PROCESSES FOR PRODUCING DURABLE HYDROPHOBIC AND/OR OLEPHOBIC SURFACES, the contents of which are incorporated herein by reference.

### FIELD OF THE INVENTION

The present invention relates to coating compositions for producing hydrophobic or super-hydrophobic surfaces and olephobic or super-olephobic surfaces, methods for forming such coating compositions, and to processes for producing such surfaces. In particular, the present invention relates to hydrophobic or olephobic powder coatings and their use for transforming surfaces of articles into hard-to-wet and self-cleaning surfaces.

### BACKGROUND OF THE INVENTION

Normal solid surfaces can be wetted by liquids such as water or oil. In many cases, surface wetting is undesirable due to the fact that a wetted surface may exhibit severely compromised functionalities, or suffer from unwanted “side-effects”. For example, protective coatings on a metal substrate may fail over time once water penetrates through the voids in the coating film. When water droplets dry off on a solid surface, especially on a smooth surface, they left behind residuals such as chemicals and dirt suspended or dissolved in the water.

The surface wet-ability is an important property of solid materials, which is determined by the chemical and physical properties of the solid, i.e., the surface energy and the surface structure of the solid. The surface energy of a solid is dependent on the surface chemical composition and the micro- and nano-scale geometrical structures of the surface which may change the contact area between water and the surface. Normally a surface with low surface energy and geometrical nano- and micro-structures would have a low wet-ability, or high water repellence. Some natural solid surfaces such as lotus leaves possess this property and demonstrate attractive advantages.

Self-cleaning is a key advantage which keeps the surface clean while rain water beads up and rolls over these surfaces entrapping dirt and particulates.

Less water remaining on the leaves and reduced water-to-surface friction are other advantages for hydrophobic plant leaves, protecting them from overloading and damage during severe storms.

The water (or oil) repellence or hydrophobicity (or olephobicity) of a solid surface can be quantified by several means including the contact angle measurement. The contact angle (CA) is defined as the angle between the horizontal solid surface and the liquid inner surface at the three phase boundary where the liquid, gas and solid intersect. A higher hydrophobicity/olephobicity of a solid leads to a higher contact angle with a liquid droplet sitting up with a more spherical shape. It has been widely accepted that a surface with a contact angle higher than 70-80° is considered as a hydrophobic surface and a surface with a contact angle higher than 130-140° is referred as a super-hydrophobic surface.

In recent years, much interest has been attracted by the natural super-hydrophobicity of solid surfaces because of their vast potential applications. Many attempts have been conducted by researchers to reproduce these properties on a variety of solid substrates in the past four decades, especially in the past few years. Potential applications of these hydrophobic surfaces include: (1) corrosion resistance and self-cleaning of materials, such as architectural coating applications (roofing, siding and windows, etc.) and vehicle protective coatings; (2) flow resistance reduction coatings for marine vessels (transportation vessels, warships, submarines, torpedoes, etc.); (3) aerospace applications for de-icing of the leading edge of airfoils and propellers; (4) anti-microbial coatings and (5) high voltage insulators that must remain non-conductive in the rain.

Endeavours dedicated to reproduction of hydrophobic or super-hydrophobic surfaces can be mainly divided into three categories according to the substrate types to be rendered hydrophobic: I) reproduction of transparent or semi-transparent hydrophobic surfaces on glass (or ceramic) substrates; II) reproduction of transparent or semi-transparent hydrophobic surfaces on textile substrates; and III) reproduction of hydrophobic surfaces on metal or other solid substrates than glass and ceramic.

For preparation of water-repellent films on glass surfaces, temporary coating methods and permanent coating processes have been disclosed. For temporarily converting glass surfaces to water-repellent surfaces, such as automobile windshield glass or household window glass, hand-applications of hydrophobic compounds on glass surfaces, as taught by U.S. Pat. No. 3,940,588, U.S. Pat. No. 4,410,563, U.S. Pat. No. 5,415,927, or adding the water-repellent liquid to windshield washer as taught by U.S. Pat. No. 6,461,537 can be used. These coatings are normally with low hydrophobicities and require frequent replenishment. For permanent hydrophobic coatings on glass surfaces, normally fluorine or silane containing organic compounds, such as alkyl silanes (C8-C12), fluoroalkylsilanes or polydimethylsiloxane (PDMS), were employed for generating low energy surfaces, and sol-gel processes were utilized to form the hydrophobic film. In many cases, nano-size silica particles are used to create nano-surface structures and to increase the durability of the hydrophobic film on glass.

U.S. Pat. No. 5,250,322 discloses a sol-gel process for forming a metal oxide film on a glass substrate with the use of a solution of a metal alkoxide. The sol contains a mixture of fluoroalkylsilane and alkoxysilane which was applied to the glass surface and then the glass was heated to obtain a hardened metal oxide film.

Wu et al. (Mat. Res. Soc. Symp. Proc., 778, U8.7.1/W7.7.1, 2003; Thin Films 200: Proceedings of 2nd International Conference on Tech. Adv. In Thin Film and Surface. Coatings, Singapore, 2004; Synthesis and Characterization of Transparent Hydrophobic Sol-Gel Hard Coatings, Journal of Sol-gel Science and Technology, volume 38, 85-89, 2005) also used sol-gel processes in their studies but polytetrafluoroethylene (PTFE), C8 and metal alkoxide (TIP), and polydimethylsiloxane (PDMS) were used as the hydrophobic material respectively and colloidal silica was used as a hardening filler for durability and for generating micro- and/or nano-surface structures.

Similar approaches have also been taken by other researchers including Takashige et al. (Mechanical Durability of Water Repellent Glass, Thin Solid Films, volume 351, 279-283, 1999), U.S. Pat. No. 6,235,383, U.S. Pat. No. 6,649,266 and U.S. Pat. No. 6,787,585 B2.

For preparation of water-repellent films on textile surfaces, attempts have been made, as disclosed in U.S. Pat. No. 6,977,094 B2, and German patents DE-A-101 18 346 and DE-A-101 18 348. In these processes, silica based hydrophobic particles suspended in a solvent are applied to a textile material and the fibre surfaces of the textile are melted by the solvent. After the solvent is evaporated the hydrophobic particles are at least partially bonded to the textile fibre surfaces, making the textile water-repellent.

For preparation of water-repellent film on metal or other solid substrates, endeavors have been mainly made in rendering liquid coatings water-repellent. U.S. Pat. No. 7,083,828 B2 describes a process which involves suspending hydrophobic particles having a volume mean particle size of between 0.02 to 100 micrometers in a solution of a silicone wax in a highly volatile siloxane, applying the suspension to the surface of an article and then removing the highly volatile siloxane. The hydrophobic particles are selected from hydrobicized silicas, zinc oxide, titanium dioxide and mixtures thereof. The hydrophobic particles demonstrated in the examples of the patent were all nano particles commercially available (Aerosil® R812S or Aerosil® R8200, Degussa AG). The inventors did not provide a preferred mass ratio range between the hydrophobic particles and the binder, the silicone wax, but the examples gave 2:1 and 4:1. For such high particle-to-binder ratios, considering the large specific surface area of the hydrophobic particles, it can be confirmed that after removing the highly volatile siloxane, the hydrophobic nano-particles are in the form of a porous matrix of particles “glued” by the binders. Thus these structured coatings might exhibit a self-replenishment effect due to the fact that although a scratch or abrasion to the surface removes some of the hydrophobic particles, the concentration of hydrophobic particles on the exposed new surface remains the same as (or similar to) that of the original surface. As a result, the hydrophobicity may hold for a period of time, but at the expense of the surface layer.

U.S. Pat. No. 6,800,354 B2 discloses using hydrophobic nano-scale and micro-scale structure-forming particles to form structures and layer-forming materials to bond hydrophobic particles to substrates that are made of glass, plastic or steel. The nano-scale structure-forming particles claimed in this patent have a volume mean particle size less than 100 nano-meters and the micro-scale structure-forming particles have a volume mean particle size from 0.1 to 50 micrometers. The layer-forming material claimed can be either inorganic, such as glass frits, or organic, such as polymers or polymeric precursors preferably in a liquid form. The coating structure from this method is geometrically similar to those disclosures for hydrophobic glass surface coatings, where the nano-scale structures are formed by nano-particles and the micro-scale structures are formed by nano- or micro-particles. The structures formed are porous given the extremely high specific surface area of the nano-structure forming material, and the claimed high mass ratio of nano-structure forming material to layer formation material (100:1 to 1:2, or 33.3% to 99% nano-structure forming material in total mixture). Again, at these high ratios, considering their large specific surface area, the hydrophobic nano-particles are in the form of a porous matrix of particles “glued” by the binders and therefore these structured coatings might exhibit a self-replenishment effect due to the same fact described earlier.

U.S. Pat. No. 6,683,126 B2 discloses a composition for producing difficult-to-wet surfaces. Again, hydrophobic particles and hydrophobic film-forming binder are used. The hydrophobic particles were specified to be 0.2 to 100 micrometers in size, particle BET>1 m²/g, either inorganic, i.e. oxide particles, or organic, i.e. polymer particles. As given in their examples, the inorganic oxide particles used were Aerosil® R812S (Degussa AG) which are commercially available and the organic polymer particles used were polytetrafluoroethylene or polypropylene powders having a particle size <36 micrometers.

The hydrophobic film-forming binder is characterized by a surface tension <50 mN/m. The particle-to-binder ratio claimed was >1:1.5 (1:1 to 1:5 for thermoplastic binders). Again, at these high ratios, considering the large specific surface area, the hydrophobic nano-particles are in the form of a porous matrix of particles “glued” by the binders and therefore the surface is not mechanically durable. However, these structured coatings might exhibit a self-replenishment effect due to the same fact described earlier, so that the hydrophobicity may sustain for a period of time.

Similar approaches were also taken in many other researches including Takashige et al. (Mechanical Durability of Water Repellent Glass, Thin Solid Films, volume 351, 279-283, 1999), U.S. Pat. No. 6,235,383 and U.S. Pat. No. 6,649,266.

Hydrophobic powder coatings were also investigated by researchers although publications are still scarce so far. U.S. Pat. No. 7,141,276 B2 discloses a powder coating composition comprising a resin component and a hardener whereby either or both of them have chemically coupled lateral and/or terminal perfluoroalkyl groups with at least one trifluoromethyl end group. The advancing contact angle with water on the substrate surface were reported as 125-140°. The coating can also be applied to the surfaces as a melt particle dispersion or dissolved solution.

U.S. Pat. No. 6,852,389 described a process to make hydrophobic surfaces using hydrophobic structure-forming particles and fixative particles which fix the hydrophobic particles to the substrate by incipient melting or sintering. One embodiment is that nano-scale fumed silica particles are mixed with fixative particles and applied to a substrate and then cured. Afterwards a hydrophobicizing agent is sprayed on the film, making both the particles and the surface hydrophobic. Another embodiment is that the fixative particles are applied to the substrate first and then the nano-size hydrophobic particles are sprinkled on the top of the substrate followed by a short curing. It was disclosed that both particles in the mixture have a volume mean particle size of less than 50 micrometers. The concentration of the structure-forming particles in the mixture is from 25% to 75%. However, the structure-forming particles given in their examples are all fumed nano-particles (Aeroperl 90/30, Aerosil® R 8200 and Sipernat 350, Degussa AG). For such a high concentration of hydrophobic particles (25% to 75%), considering the large specific surface area, the hydrophobic nano-particles are in the form of a porous matrix of particles “glued” by the binders and therefore these structured coatings might exhibit a self-replenishment effect due to the same fact described earlier. Again, however, the high particle to binder ratio leads to weak mechanical strength.

On the other hand, some of those reported hydrophobic coatings for glass substrates (but not other substrates) have been relatively more successful in term of the mechanical durability. Some of the literature has shown coatings with reasonable mechanical abrasion resistance. For instance, the methods disclosed in Takashige et al. (Mechanical Durability of Water Repellent Glass, Thin Solid Films, volume 351, 279-283, 1999) enable a hydrophobic coating (with initial water contact angle of 116°) on a glass surface surviving 40,000 rubs (of flannel cloth under load of 1.2 kg) with the contact angle remaining over 110°, although for applications such as windshield, much more durable coatings are required. On the other hand, the reported compositions and processes of coatings on glass substrates are complicated, time consuming and costly. They use many chemical components through special multiple processing steps with tightly restricted operating conditions. However, it is still economically acceptable due to the high value of the substrate, e.g., windshield glass of automobiles.

It is not economically and industrially feasible to apply the above mentioned prior-arts for glass surfaces to most of other solid surfaces, such as those of metals. For example, none of the prior-arts can produce a hydrophobic coating surface on a metal substrate or any other surface with reasonably acceptable mechanical durability other than glass. Production of a hydrophobic coating surface that is both hydrophobic (especially super-hydrophobic) and mechanically durable (retain-ability of the hydrophobicity and strength of the film), is challenging because these two important properties are often conflicting to each other with the approaches of the prior arts.

In general, for solid substrates other than glass and textile, two different approaches have been disclosed, one approach disclosed in U.S. Pat. No. 7,141,276 B2 teaches preparation of coating films with compositions containing hydrophobicized resin(s) and hardener(s); and the other approach disclosed in U.S. Pat. No. 7,083,828 B2, U.S. Pat. No. 6,800,354 B2, U.S. Pat. No. 6,683,126 B2 and U.S. Pat. No. 6,852,389 discloses preparation of coating films with compositions comprising hydrophobic particles and film forming material(s).

The first approach does not provide super-hydrophobicity because nano- and micro-structures are difficult to attain. The second approach disclosed in the four U.S. patents has very high particle-to-binder ratios, between 1:2 and 100:1 and the reason for using such high particle-to-binder ratios is to obtain and retain super-hydrophobicity (from self-replenishment effect). However, the hydrophobic coatings prepared with such high particle-to-binder ratios would be porous throughout the film and thus the resistance to water droplet impact and the overall mechanical strength would be unacceptable for most applications.

Therefore, there is a need for providing coating compositions useful for producing hydrophobic or super-hydrophobic surfaces and olephobic or super-olephobic surfaces with acceptable mechanical durability, and for applying these coating compositions to surfaces.

### SUMMARY OF THE INVENTION

Embodiments of the present invention are directed to coating compositions for producing hydrophobic or super-hydrophobic surfaces and olephobic or super-olephobic surfaces, and to processes for producing such surfaces.

Accordingly, embodiments of the invention provides a compositions for coating surfaces which are either hydrophobic or olephobic or both, super-hydrophobic or super-olephobic or both and which are mechanically durable in retaining hydrophobicity and/or olephobicity and in regards to mechanical film strength. The hydrophobic and/or olephobic film can sustain hard rubbing, high pressure water impact, finger pressing with water or oil (or by other objects with water or oil).

Embodiments of the invention provide coating compositions, preferably powder coating compositions, for hydrophobic or super-hydrophobic and/or for olephobic or super-olephobic surfaces, which form films with continuous base layers adjacent to the substrate surfaces and with nano- and micro-structured surfaces at the top.

Embodiments of the invention provide coating compositions, preferably powder coating compositions (but could be liquid based), for hydrophobic or super-hydrophobic and/or for olephobic or super-olephobic surfaces, which are simple and easy to produce.

Embodiments of the invention provide processes for the production of the hydrophobic or super-hydrophobic and/or olephobic or super-olephobic surfaces, which are simple and easy to implement, preferably executable with current powder coating production equipment.

Embodiments of the invention provide compositions of powder coatings for hydrophobic or super-hydrophobic and/or for olephobic or super-olephobic surfaces, which can be applied on solid surfaces with current powder coating application methods.

In one aspect, the present disclosure provides a method for forming a coating composition for application to a surface, comprising:

a) forming conglomerates by
providing a plurality of nano-sized particles having a mean diameter in a range from about 1 to about 500 nanometers, the nano-sized particles having hydrophobic, super-hydrophobic, olephobic, or super-olephobic properties,
mixing the plurality of nano-sized particles with a binding material to form a mixture and heating the mixture to induce curing to bind the nano-sized particles to form a consolidated cake-form material;
cooling the consolidated cake-form material and grinding the cake-form material to produce conglomerates having a size in a range from about 1 micron to about 40 microns; and

b) mixing the conglomerates with a coating material to be applied to a surface, said binding material being one of a thermosetting resin and a thermoplastic resin having a melting temperature higher than a curing temperature of the coating composition.

The present invention also provides a hydrophobic coating composition for coating a surface, comprising:

a plurality of conglomerates, including nano-sized particles having hydrophobic, super-hydrophobic, olephobic, or super-olephobic properties, and a bonding material for binding the nano-sized particles together to form said plurality of conglomerates, said bonding material being one of a thermosetting resin, and a thermoplastic resin having a melting temperature higher than a curing temperature of the hydrophobic coating composition; and

a coating composition into which the plurality of conglomerates are mixed for application to said surface to be coated.

The present invention also provides a hydrophobic coating formed using the hydrophobic coating composition of claim 1 produced by a method comprising the steps of:

a) applying said hydrophobic coating composition to a surface to form a coating; and

b) curing said hydrophobic coating composition applied to said surface, wherein some of the nano-sized hydrophobic particles are present at a top surface of the coating to impart hydrophobic properties to the top surface.

The present invention also provides hydrophobic coating composition for coating a surface, comprising:

a plurality of glass structures having nano-size particles exhibiting hydrophobic, super-hydrophobic, olephobic, or super-olephobic properties, wherein the plurality of glass structures are chemically bonded to a surface of the glass, wherein a volume mean particle size of the glass structures is between about 1 and about 40 micrometers, and wherein the glass structures have a diameter in a range from about 0.1 to about 1000 micrometers; and

a coating composition blended with the plurality of glass structures, said coating composition being one of a thermosetting resin, and a thermoplastic resin which upon curing gives a hydrophobic coating.

The present invention also provides a hydrophobic coating composition for coating a surface, comprising:

a hydrophobic additive including a mixture of porous micro-size particles and nano-size particles, wherein the nano-size particles exhibit hydrophobic, super-hydrophobic, olephobic or super-olephobic properties, and wherein a mass ratio of the nano-size particles to the porous micro-size solids particles is in a range from about 1:0.5 to about 1:50, a volume mean size of the nano-size particles is in a range from about 1 to 1000 nanometers, and a volume mean size of the porous micro-size solids particles is in a range from about 1 to about 40 micrometers; and

a coating composition blended with the hydrophobic additive for application to said surface to be coated, said coating composition being one of a thermosetting resin, and a thermoplastic resin which upon curing gives a hydrophobic coating.

A further understanding of the functional and advantageous aspects of the invention can be realized by reference to the following detailed description and drawings.

### BRIEF DESCRIPTION OF THE DRAWINGS

Further features, objects and advantages will be evident from the following detailed description of the preferred embodiments of the present invention taken in conjunction with the accompanying drawings in which;

FIG. 1 shows a coating surface (1), a substrate (2) and a coating film (3);

FIG. 2 schematically illustrates the definition of the apparent particle volume for particles having a porous and/or frame structure;

FIG. 3 shows a cross-sectional view of an embodiment of a coagulate and/or conglomerate of pre-bonded nano-size hydrophobic particles;

FIG. 4 shows a cross-sectional view of another embodiment of a coagulate and/or conglomerate in which hydrophobic particles are protected by porous solid particles; and

FIG. 5 shows a cross-sectional view of an embodiment of a hydrophobic glass bead and/or glass bubble.

### DETAILED DESCRIPTION OF THE INVENTION

The systems described herein are directed, in general, to coating compositions for producing hydrophobic or super-hydrophobic surfaces and olephobic or super-olephobic surfaces, and to methods or processes for producing such coating compositions and such surfaces.

Although embodiments of the present invention are disclosed herein, the disclosed embodiments are merely exemplary and it should be understood that the invention relates to many alternative forms. Furthermore, the figures are not drawn to scale and some features may be exaggerated or minimized to show details of particular features while related elements may have been eliminated to prevent obscuring novel aspects. Therefore, specific structural and functional details disclosed herein are not to be interpreted as limiting but merely as a basis for the claims and as a representative basis for enabling someone skilled in the art to employ the present invention in a variety of manner. For purposes of instruction and not limitation, the illustrated embodiments are all directed to embodiments of apparatus and methods for coating compositions for producing hydrophobic or super-hydrophobic surfaces and olephobic or super-olephobic surfaces, and to methods or processes for producing such surfaces.

As used herein, the term “about”, when used in conjunction with ranges of dimensions of sizes of particles or other physical properties, temperatures or other chemical characteristics, is meant to cover slight variations that may exist in the upper and lower limits of the ranges of dimensions of particles so as to not exclude embodiments where on average most of the dimensions are satisfied but where statistically dimensions may exist outside this region. It is not the intention to exclude embodiments such as these from the present invention.

As used herein, the term “hydrophobic” means the property of a surface which is water-repellant and shows a large contact angle (defined earlier) of higher than 70-80°, in regard to water droplets sitting on the surface.

As used herein, the term “super-hydrophobic” means the property of a surface which is very water-repellant and shows a very large contact angle (defined earlier) of higher than about 130-140° in regard to water droplets sitting on the surface.

As used herein, the term “olephobic” means the property of a surface which is oil-repellant and shows a large contact angle (defined earlier) of higher than about 70-80°, in regard to oil droplet sitting on the surface.

As used herein, the term “super-olephobic” means the property of a surface which is very oil-repellant and shows a large contact angle (defined earlier) of higher than about 130-140°, in regard to oil droplet sitting on the surface.

As used herein, the term “nano-size particles” refers to particles having a mean particle size (diameter) in a range between about 1 to about 500 nanometers.

As used herein, the phrase “micro-size particles” refers to particles having a mean particle size (diameter) in a range between about 1 to about 100 micrometers.

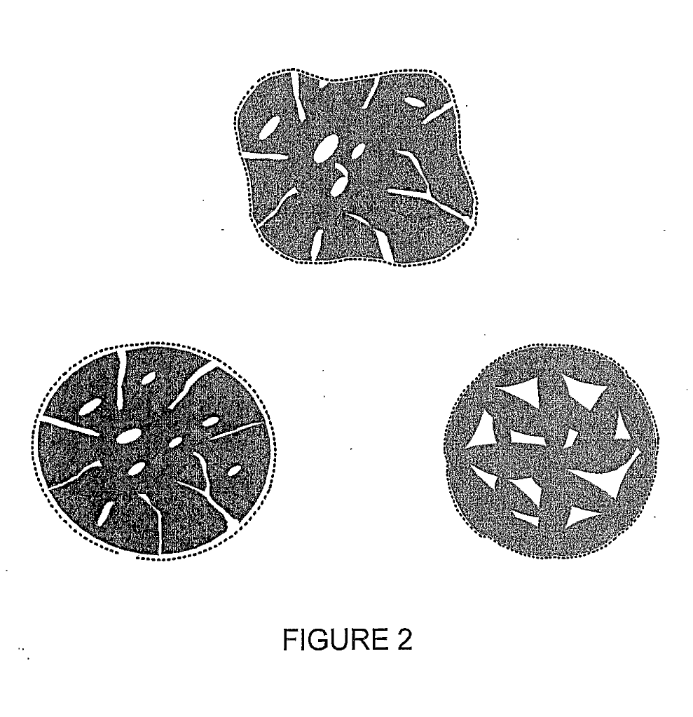

As used herein, the phrase “porous micro-size particles” refers to particles having internal pores and cavities as shown in FIG. 2 and having a mean particle size (diameter) in a range between about 1 to about 100 micrometers.

It will be understood that the terms “coagulate” and “conglomerate” are interchangeable terms as used in this patent application.

As used herein, the phrase “volume mean size” refers to a particle size that is equivalent to the diameter of a spherical particle that has the same volume of the particular particle that is referred to. As shown by the dashed lines in FIG. 2, the volume of the particle is defined as the volume that is contained within the outskirt of the particular particle, including the volume of pores that are within the outskirt of the particle boundary.

It should be understood that while the terms “hydrophobic” and “super-hydrophobic” are used more predominantly in the present disclosure, they also include “olephobic” and “super-olephobic” whenever applied.

Furthermore, while most descriptions mention powder coating, the same can be true for liquid coating. The term “coating materials” is general and may describe embodiments of either liquid or powder coating materials.

Regarding powder coating, it has been found from the reproduction tests of the known art, conducted by the inventors of the present invention, that simply dry-blending nano-size hydrophobic particles (e.g., Aerosil® R8200 or Aerosil® R815S, Degussa AG) in a powder coating material at a lower concentration, e.g., less than 1.0% wt, does not provide a surface with significantly high hydrophobicity (i.e. with water contact angle of 90° or above) although a perfect continuous film can be obtained. A higher concentration, between 1.5% and 3.0% wt, offers a structured surface (in both nano- and micro-scales) with a fairly continuous film underneath and may give a good initial hydrophobicity with a water contact angle higher than 120°. But in both cases, the coating does not retain its hydrophobicity against mechanical abrasion. Simple rubbing a few times using a finger results in failure of the coating. This is because the functional material, the nano-size hydrophobic particles on the top surface of the film, does not have a sturdy bonding with the paint system and therefore, they can be easily rubbed off.

Further increasing the concentration would make it difficult to form a continuous film and often leads to a sponge-like structure. In this case, abrasions applied to the top of the film will not only remove the hydrophobic particles, but will leave exposed a new array of hydrophobic particles. This makes the hydrophobicity of the coating look “retainable” due to the self-replenishment effect. However, these types of sponge-like hydrophobic coatings do not retain their hydrophobicity when water or water drops impact on the surfaces with moderate to high speed, e.g., when exposed to rain, or when pressing the surface by a finger with water. This is because the momentum of water or the pressure exerted on water pushes the water into the pores of the film and thus makes the hydrophobicity fail. Also, when water penetrates into the matrix of the coating which is porous throughout the whole film, other functions of the coating, such as corrosion protection, would fail. In addition, with this type of sponge-like structure throughout the whole film, the overall strength of the film is drastically reduced and the whole film would come off under repeated rubbing. In other words, this type of film, although retaining a self-replenishment capacity to a certain extent, exhibits poor resistance to high pressure water, poor protection to the substrate and low mechanical strength.

In summary, according to the findings from the literature and tests conducted by the inventors of the present invention, it has been found that the most critical issue related to forming a mechanically durable hydrophobic coating film is the weak bonding between the hydrophobic nano particles, or other nano structure that provide hydrophobic property, and the coating film. Because of this, when the fraction of nano hydrophobic particles in the coating is low, the hydrophobic property fails easily; when a high fraction of nano hydrophobic particles are used, the coating surface may be able to maintain its hydrophobic property to a certain extent at the expense of the attrition of the materials at the top of the film due to a self-replenishment mechanism. However, the latter not only cannot last much longer, it also causes other problems such as the overall mechanical weakness of the film and compromised corrosion protection due to the porous structure of the coating film.

Therefore, a good hydrophobic coating for solid substrates should have the following three major characteristics:

1) The coating should have a mixed nano-and micro-structured top layer with inherent hydrophobicity due to at least some of the material(s) of which the top layer is composed. This provides the function of hydrophobicity. Such nano structure, however, may not need to be made from nano particles including nano particles which come with hydrophobic properties. It can be from a process which forms the nano structures, e.g., through non-uniform growing or shrinking materials.

2) The hydrophobic materials that form the nano structures in the top layer have to be either well affixed to the film directly and/or through some other media, by such methods as bonding or trapping, or protected from being rubbed off by some other means.

3) The coating should have a consolidated (continuous) base bulk layer in the film which is well bonded to the substrate, to provide a strong base for the top layer and the protective function to the substrate, if needed. These ensure the hydrophobicity of the film coating, the mechanical durability of the hydrophobicity as well as the protective function of the coating film when required.

The following describes the methods employing coating compositions to achieve the above listed characteristics. Those should, however, only be considered examples but not as limiting the scope of this invention.

A goal of the present invention, is to firstly provide hydrophobic nano-sized structures on the surface of micro-size objects and then secondly to affix (for example, via bonding) the micro-sized objects into the coating film. In this way, the nano-sized structures that have hydrophobic properties (e.g., nano-sized hydrophobic particles) are strongly affixed to the base coating film so as to give greatly enhanced mechanical durability to the hydrophobic coating surface. Forming hydrophobic nano-sized structures on the surface of micro-size objects can be done by at least one of the following methods:
(1) affixing hydrophobic nano-sized particles onto the surface of the micro-size objects, including bonding and/or trapping the hydrophobic nano-sized particles to the micro-sized objects;
(2) affixing non-hydrophobic nano particles onto the surface of the micro-size objects and then hydrophobicizing the nano particles after attachment;
(3) having micro-size objects that already have nano-structures incorporated therein and then hydrophobicizing those nano-sized structures; or
(4) having micro-size objects that initially do not have nano-sized structures or only have very limited nano-sized structures, then producing nano-sized structures on them, and finally hydrophobicizing those nano-sized structures.

It is noted that in methods (2) through (4), the portion of the surfaces of the micro-sized objects not covered by nano particles may also be hydrophobicized while hydrophobicizing the nano-sized structures already incorporated into the micro-sized structures. This, however, can only enhance the overall hydrophobicity of the micro-size particles, not compromise it.

For bonding the micro-size objects onto the coating film, it can be done by at least one of the following methods:
(A) mixing the micro-size objects into the coating materials before applying the coating and then applying the mixture thereafter, followed by curing or other bonding process;
(B) applying the micro-size objects to the coating surface after the rest of the coating materials have been applied onto the substrate, before or during the curing or other bonding process;
(C) mixing the micro-size objects with a small fraction of the coating materials and then applying the mixture thereformed to the coating surface after the rest of the coating materials have been applied onto the substrate, before or during the curing or other bonding process; or
(D) applying the micro-size objectives in method (B) and/or the mixture in method (C) to the coating surface after the other coating materials have been cured or bonded by other ways, in which case a second curing or bonding procedure may be required as well as the application of additional boning materials.

Another function of the micro-size structure is to promote the formation of micro structures on the coating surface. In general, to ensure the best performance of the hydrophobic coating, it is best to have both micro- and nano-sized structures present in the coating. While the nano-sized structures are hydrophobic and provide the hydrophobic function to the coating (or whatever other functions the nano-sized structures possess), the micro-sized structures help to further reduce the actual contact area between the liquid and the coating surface which further assists the hydrophobicity function, as well as to protect the nano structure from extensive damage.

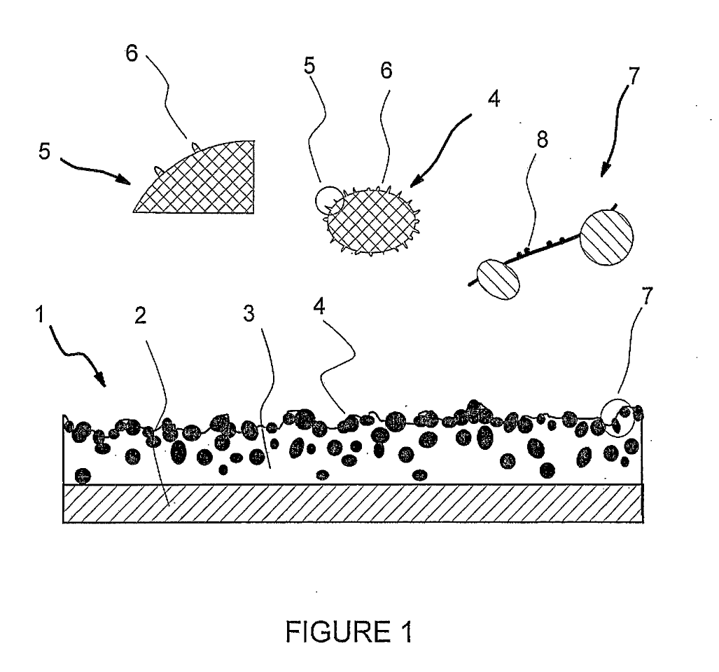

FIG. 1 shows a coated substrate generally at (1), where (2) is the substrate and (3) is the coating film. A key feature is to have some micro-size objects (4) fixed at the coating surface, with possibly some more micro-size objects inside the coating film. Another key feature is that each of the micro-size objects (4), include some nano-sized structures (6) on the surface. Reference numeral (5) represents a blowout of a portion of the micro-size object (4) which shows more clearly the nano structure (6) on the surface of the micro-size objects (4).

Another feature is that nano-sized structures may also be present directly on the surface of the coating film (3). This is shown as numeral (7) in the blow-up in FIG. 1, wherein nano structures (8) are fixed directly onto the surface of coating film (3).

The micro-sized objects can be coagulates and/or conglomerates or other types of solid or gel-types of particles. Preferably, these micro-size objects should have a size range from about 0.1 to about 1000 micrometers, more preferably have a size range from about 1 to about 100 micrometers, and even more preferably have a size range from about 5 to about 40 micrometers.

There are several methods to create the combined nano-particle/micro-particle structures. The following describes several methods to form the above-discussed micro-size objects (also referred to as the second particles) that have hydrophobic features on their surface. Those should, however, only be considered as examples and not as limiting the scope of the present invention.

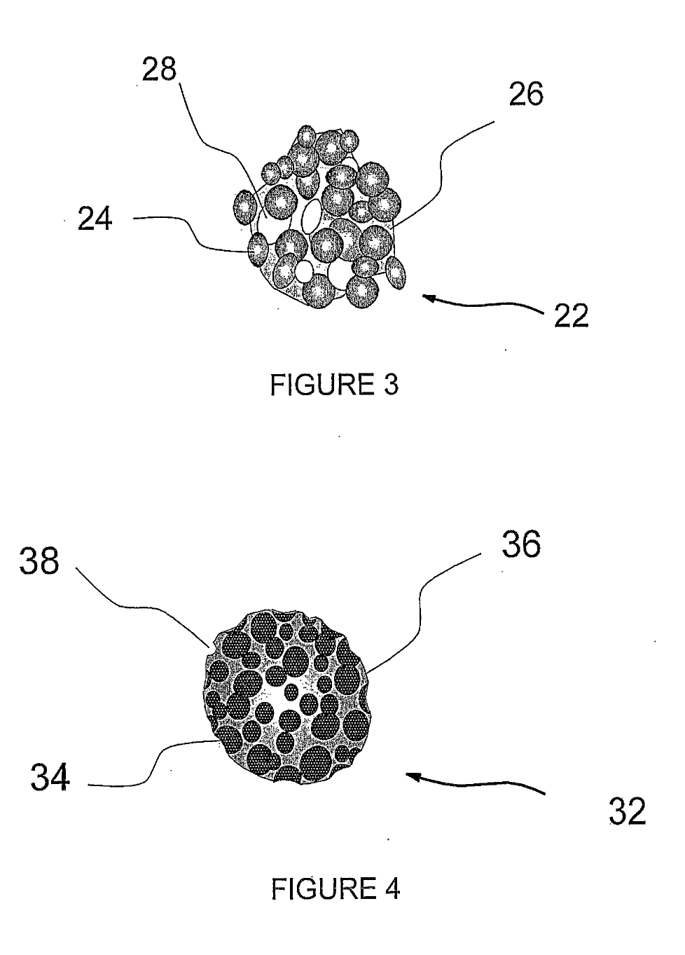

Method I: Preparation of Conglomerates formed by Pre-Bonding Hydrophobic Particles and Process Thereof (FIG. 3)

As shown in FIG. 3, in order to ensure the fixation of nano-size hydrophobic particles (24) to the surface of the finished coating film (1) (as shown in FIG. 1), the particles (24) (also referred to as primary particles) may be pre-bonded with each other by a bonding material (26) through a special fuse-bonding process or some other processes which can achieve the same purpose, to form coagulated and/or conglomerated particles (22). Each of the conglomerates (22), also referred to as the secondary particles, preferably comprises a plurality primary particles (24) which are strongly bonded with each other by the bonding material (26), but the surface of the conglomerates (22) should have a certain amount of exposed surfaces of the primary particles (24) which are hydrophobic particles for this case.

The primary nano-size hydrophobic particles (24) can be selected from materials commercially available such as Aerosil® R815S, Aerosil® R8200, or can be self-made nano-size particles, e.g., fumed silica particles coated with hydrophobic material(s). The bonding material (26) may be selected from thermosetting resin systems such as epoxy, polyester, epoxy-polyester hybrid, polyurethane, acrylic etc. or a mixture thereof, or from thermoplastic resin systems such as polyethylene (PE), polypropylene (PP), polychloroethene (PVC), polystyrene (PS), acrylonitrile butadiene styrene (ABS), polyamide (PA), polycarbonates (PC), polyphenylene oxide (PPO), polyurethane (PU), polytetrafluoroethylene (PTFE), polybutylene terephthalate (PBT), polyethylene terephthalate (PET), polyacrylate, polyphenylene sulfide (PPS), nylon, and mixtures thereof, as long as its melting temperature is higher than the curing temperature of the film-forming coating materials, or any combination of the above. Other bonding materials can also be used.

Experimental results showed that a preferred mass ratio of the nano-size hydrophobic particles (24) to the bonding material (26) is within 1:10 and 2:1, preferably within 1:5 to 1:1 and, the finer the particles (24), the better the bonding that is achieved. The nano-size hydrophobic particles (24) and the bonding material(s) (26) are well mixed before the fuse-bonding process, to break down the agglomerates of the two materials. One way to conduct the fuse-bonding process is to press the bulky mixture to make it a much more consolidated cake-form material, and concurrently or subsequently heat the mixture either to the curing temperature of the thermosetting bonding material for an amount of time required for curing or to the melting temperature of the thermoplastic bonding material.

This pressing and heating operation results in the primary nano-size hydrophobic particles (24) being intimately bonded to each other by the bonding material (26) although there may still exist some voids (28) between the particles (24) (this structure is preferred so that the primary particles (24) are not necessarily completely covered by the bonding material). After the cake-form material cools down, it is ground down to an average size which is significantly larger than the average size of the primary particles (24). The final product of this step, referred to as conglomerate (22) of primary particles (24), normally with a volume mean particle size of preferred size as mentioned above, most preferably from about 1 to about 40 micrometers. There normally also exists a small fraction of free nano-size hydrophobic particles (24) in the product of this step, which are not bonded to the other particles.

The primary particles (24) used in this embodiment may also be non-hydrophobic nano-size particles which can then be hydrophobicized after the fuse-bonding process or even after the cakes are ground down. Furthermore, the primary particles (24) used can also be in the micro-size range, provided that the second particles (22) are composed of a plurality of primary particles (24) and are still in the preferred particle size range as mentioned above.

The conglomerates (22) thus formed can then be mixed into a coating composition for application onto substrates to form coating films. The coating composition may include a solvent into which the conglomerates are mixed so that the hydrophobic coating composition is applied to a surface as a liquid and cured such that the solvent evaporates. Alternatively, the coating composition may include a powder (which may be the same as the bonding material discussed above) so that the hydrophobic coating composition is applied as a powder.

It shall be understood that the above-mentioned methods are only exemplary and many other methods can be used to produce the conglomerates (22). One can also use some naturally formed conglomerates and/or coagulates to replace the conglomerates made using the above procedure. For example, there are mineral products that are in the desirable size range and that also have the micro and nano structure as described above. They can be first hydrophobicized and then used to replace the man-made coagulates described above.

Method II: Preparation of Conglomerates with Nano-Size Hydrophobic Particles Protected by Porous Solid Particles (FIG. 4)

Referring to FIG. 4, another method to form coagulated and/or conglomerated particles shown generally at (32) is to use porous micro-size particles (36) and to incorporate nano-size hydrophobic particles (34) into the pores (38) of the porous micro-size solid particles (36) (other materials can also be present). The conglomerates (32) thus formed can then be mixed into coating materials for application onto substrates to form coating films. Some non-limiting examples of coating materials that may be used include one or more of: thermosetting resin, thermoplastic resin, pigment(s) for colour coating, solvents, or other additive materials such as a curing agent or flow agent. It would be understood by those skilled in the art that other coating materials may be used. As used herein, the term “coating materials” is general and may describe embodiments of either liquid or powder coating materials.

One method to incorporate the nano particles (34) into the porous micro-size solids particles (36) is to vigorously mix the nano-size hydrophobic particles (34) and the porous micro-size solids particles (36). When both the nano-size hydrophobic particles (34) and the porous micro-size particles (36) are undergoing a harsh mixing process, a fraction of the nano-particles (34) will be entrapped in the pores (38) of the micro-size porous particles (36), resulting in conglomerates (32) with the micro-size porous particles (36) as base structure and the nano hydrophobic particles (34) giving the conglomerates (32) the hydrophobic properties.

It is also possible and sometimes may be beneficial to include other materials into the above mixing process, such as, but not limited to some non-hydrophobicized nano particles to enhance the mixing and/or the trapping of the nano-sized hydrophobic particles into the pores (38) of the micro-size porous particles, or liquid or nano-size bonding materials to create additional bonding forces between the nano-size hydrophobic particles and the micro-size porous particles (36). Curing or other form of bond setting procedure may be required for the last step.

The conglomerates (32) thus formed may also be referred to as secondary particles and can then be mixed into the coating materials for application onto substrates to form coating films.

Experimental results showed that the optimum or preferred mass ratio of the nano-size hydrophobic particles (34) to the porous micro-size solid particles (36) is between about 1:0.5 and about 1:50, depending upon the type and properties of the two kinds of particles. The optimum volume mean size of the porous micro-size solids particles is between about 1 to about 40 micrometers.

To produce powder coating, there is another method to form the conglomerated particles (32) by using porous micro-size particles (36) with nano-size hydrophobic particles (34) incorporated into the pores (38) of the porous micro-size particles: The nano-size hydrophobic particles (34) and the porous micro-size solid particles (36) can be mixed together with powder coating materials. The powder coating materials may include one or more of: thermosetting resin systems such as epoxy, polyester, epoxy- polyester hybrid, polyurethane, acrylic etc. or a mixture thereof, or from thermoplastic resin systems such as polyethylene (PE), polypropylene (PP), polychloroethene (PVC), polystyrene (PS), acrylonitrile butadiene styrene (ABS), polyamide (PA), polycarbonates (PC), polyphenylene oxide (PPO), polyurethane (PU), polytetrafluoroethylene (PTFE), polybutylene terephthalate (PBT), polyethylene terephthalate (PET), polyacrylate, polyphenylene sulfide (PPS), nylon, and mixtures thereof, or any other binder. It would be understood by those skilled in the art that other powder coating materials may be used.

When a powder coating including both nano-size hydrophobic particles (34) and porous micro-size solid particles (36) is undergoing a harsh mixing process, a fraction of the nano-particles (34) and a small fraction of the powder coating particles (with finer sizes) will be entrapped in the pores (38) of the micro-size porous particles (36) in the resulting powder coating. The conglomerates (32) thus formed may also be referred to as secondary particles. During the curing process of the applied film using the coating powder containing these secondary particles (32), the entrapped nano-particles (34) are bonded in the pores (38) of the micro-size porous particles (36) although the bonding may not necessarily be very strong. However, they are geographically hidden in the pores (38) and mechanically protected by the outer surfaces of the porous particles (36).

Again for powder coating, it is also found that pre-mixing the hydrophobic nano-size particles with the micro-size porous particles in the presence of a fraction of the powder coating materials instead of the complete coating formulation gives better abrasion resistance of the hydrophobic film, because such pre-mixing provides more chances for the nano-size particles to penetrate into the pores. The optimum mass ratio of the nano-size hydrophobic particles (34) to the porous micro-size solid particles (36) is the same as the previous case, i.e, between about 1:0.5 and about 1:50, depending upon the type and properties of the two kinds of particles. The optimum volume mean size of the porous micro-size solids particles is similar as the previous case, i.e., between 1 and 40 micrometers. It is beneficial to mix the two components with their optimum mass ratio, in a high-shear mixer or similar means to ensure a good penetration.

Some grades of zeolites and diatomites are found very effective in providing abrasion protection to the hydrophobic surfaces. Zeolites are minerals having micro-porous structures, either naturally occurring or synthesized. Diatomites consist of fossilized remains of diatoms, a type of hard-shelled algae, which are highly micro-pore-structured as well.

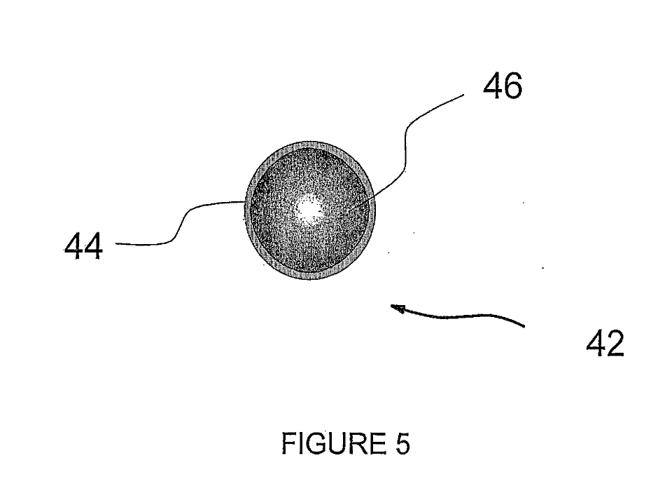

It should be noted that, another process of preparing the hydrophobic conglomerates using micro-pore-structured solid particles is to hydrophobicize these particles themselves (without the addition of nano hydrophobic particles) using a variety of methods such as the sol-gel techniques similar to those used for glass beads (or bubbles) as described hereinafter with respect to FIG. 5. Likewise, formulation of the sol and the mass ratio of the sol to the micro-pore-structured solid particles have to be tightly controlled so that the coated particles will not cake up, making it hard to break down. Again, slightly caking is normally hard to avoid. A light grinding process would de-cake the material.

Method III: Preparation of Conglomerates with Hydrophobic Glass Beads or Glass Bubbles (FIG. 5)

Hydrophobic coatings prepared on glass surfaces exhibit quite high mechanical durability against rubbing, as is known in the art and based on tests conducted by the inventors of the present invention. The main reason is that the hydrophobic nano-size particles can be chemically bonded to the glass surface with properly formulated bonding materials and appropriate bonding processes. The techniques used for regular glass surfaces can be easily applied to glass beads or glass bubble surfaces to form the micro-size objectives referred to herewith. Experimental results show that one best process is to firstly fix the nano-size particles, preferably fumed silica, to the surfaces of glass beads or glass bubbles using a sol-gel process, and then hydrophobicize the nano-size particles fixed on the surfaces of glass beads or glass bubbles. The optimum volume mean particle size of glass beads or glass bubbles is between about 5 and about 40 micrometers, but may fall outside this range. As mentioned before, the micro-size objects formed based on glass beads or bubbles may have a diameter anywhere in a range from about 0.1 to about 1000 micrometers, more preferably have a size range between about 1 to about 100 micrometers, and even more preferably have a size range between about 5 to about 40 micrometers.

A typical two-step procedure developed by the inventors of the present invention is described as follows. Referring to FIG. 5, in the first step, glass beads (46) are washed with an organic solvent such as acetone, followed by water to ensure that they have the maximum exposed surface for application of a silica sol-gel. The silica sol-gel is comprised of fumed silica and a TEOS (tetra ethyl oxysilane) sol-gel that includes ethanol, TEOS and 0.1 M HCl solution. The fumed silica is firstly dispersed in a sol-gel of ethanol and TEOS uniformly, then HCl solution is added followed by the complete hydrolysis through an aging process. During the aging process, amorphous silica particles are generated from the hydrolisation of TEOS in ethanol and attracted by the fumed silica particles to form semi-amorphous silica sol-gel.

Glass beads are then put in the silica sol-gel and the suspension gradually dries up at room temperature with constant stirring. A thermal treatment afterward further solidifies the attachment and creates a durable nano-structured layer (44) on the outer surface of the glass particle (46). The amount of the fumed silica added is 5 to 50% of the TEOS by mass. The ratio of silica sol-gel to glass beads is 0.5 ml:1 g to 5 ml:1 g. Slight caking is normally hard to avoid. A light grinding process may be used to de-cake the material.

In the second step, the de-caked pre-coated glass beads are then mixed with a hydrophobicizing solution, dried up at room temperature with constant stirring and then thermo-treated with elevated temperature of 200° C. for about 1 hour. The hydrophobicizing solution is used to functionalizing the nano-structured layer (44) previously coated on the glass beads surface. It is comprised of ethanol, FAS (Fluoro-alkyl Silane) and 0.1 M HCl in volume ratio of 15:2:2. The ratio of hydrophobicizing solution to glass beads is 0.5 ml:1 g to 4 ml:1 g. This ratio also needs to be controlled within the range. A higher amount of hydrophobicizing solution makes the glass beads hard to dry up during the thermal treatment while a lower amount does not provide enough hydrophobicity. The product of this step is hydrophobicized glass beads coated with durable hydrophobic coating (44) shown generally as (42) in FIG. 5. Such hydrophobicized glass beads (42) or glass bubbles are also referred to as secondary particles.

In the event glass bubbles are used instead of glass beads, they are treated in the same manner with the exception that the ratios of glass bubbles to silica sol-gel and to hydrophobicizing solution is recalculated according to the specific area per gram of the glass bubbles relative to that of glass beads.

Alternatively, other materials such as ceramic beads may also be used to replace glass beads (13) or bubbles in the above described process.

Preparation of Hydrophobic Coating Composition Using the Conglomerates and/or Glass Beads/Bubbles with Hydrophobic Properties

The micro-size objects (the conglomerates and/or the hydrophobicized glass beads/bubbles) prepared as described above are mixed with the required coating materials to produce liquid or powder coating compositions. In terms of a powder the micro-sized objects are first dry-blended with a powder coating material selected from thermosetting resin systems such as epoxy, polyester, epoxy- polyester hybrid, polyurethane, acrylic etc. or a mixture thereof, or from thermoplastic resin systems or any other binder. From the experimental results, a preferred mass ratio of the coagulates to the powder coating material is between 1:20 and 1:2. When the final coating is formed, the nano hydrophobic structure gives the hydrophobic feature of the coating and the micro-size secondary particles result in micro structures on the finished film which, among other things, can help further reduce the contact area as well as protect the nano hydrophobic structure from extensive mechanical disruption. A small amount of nano-size hydrophobic particles may also be optionally added, intentionally or as part of the process (such as in Method II shown in FIG. 4), which are referred to as free nano-size hydrophobic particles, which can further create more nano-size hydrophobic structures on the coating surface, but may also aid in the formation of a micro-structure on the finished film surface after the coating is formed.

When it is desired to make a liquid coating composition, the micro-sized objects are first blended with a liquid coating material selected from various resin systems such as epoxy, polyester, polyurethane, acrylic etc. or a mixture thereof, either in oil-borne water-borne. From the experimental results, a preferred mass ratio of the coagulates to the solid content of the liquid coating material is between 1:20 and 1:2. When the final coating is formed, the nano hydrophobic structure gives the hydrophobic feature of the coating and the micro-size secondary particles result in micro structures on the finished film which, among other things, can help further reduce the contact area as well as protect the nano hydrophobic structure from extensive mechanical disruption. A small amount of nano-size hydrophobic particles may also be optionally added, intentionally or as part of the process, which are referred to as free nano-size hydrophobic particles, which can further create more nano-size hydrophobic structures on the coating surface, but may also aid in the formation of a micro-structure on the finished film surface after the coating is formed.

Proper mixing methods should be utilized to ensure uniform dispersion of the mixture components in the final product. The resultant hydrophobic coating can be applied to substrates (2) using current application methods, such as electrostatic spraying.

Finished Hydrophobic Film Prepared with the Hydrophobic Coating

During the curing or other film coating process, the applied coating layer flows, and in the case of powder coating, melts and flows, to form a continuous paint film (3) shown in FIG. 1. While the exposed hydrophobic surface on the secondary particles (conglomerates (4) and/or hydrophobicized glass beads/bubbles (42)) and the free nano-size hydrophobic particles causes the top layer of the film (3) form a hydrophobic surface, the relatively large size secondary particles (conglomerates (4) and/or hydrophobicized glass beads/bubbles (42) result in micro structures on the finished film which, among other things, can help further reduce the contact area as well as protect the nano hydrophobic structure from extensive mechanical disruption. After curing, the surface comprises a hydrophobic nano-structure formed by the exposed nano-size particles on the popped-out surface of the micro-size secondary particles plus optionally the hydrophobic nano-structure formed by those free nano-size particles which made to the surface, and a micro-structure formed by the micro-size secondary particles, aided by the free nano-size hydrophobic particles.

Referring to FIG. 1, the resulting films (1) exhibit three characteristics proposed by this invention: 1) a consolidated and continuous base layer in the coating film which is well bonded to the substrate, to provide a strong base for the top layer and the necessary protection to the substrate (2); 2) a nano- and micro-structured top layer on the coating film (3) with inherent hydrophobicity from at least some of the material(s) of which the top layer is comprised; and 3) the hydrophobic structures in the top layer are well affixed to the film either directly or through other media to ensure a strong mechanical durability of the hydrophobicity.

It is noted that the addition of micro-size secondary particles contributes to the creation or the enhancement of the micro-structure on the top layer of the finished film, which is important for generating a super-hydrophobic surface, both in term of reducing the contact area and in term of protecting the nano structures. In addition, however, micro-structures can also be formed, in the absence of the secondary particles, by a lager amount of free nano-size hydrophobic particles in the coating composition. Those nano-sized hydrophobic particles can alter the rheological property of the coating composition during the curing process and thus result in the formation of the micro-structured top film.

Beside the excellent results in generating mechanically durable hydrophobic or super-hydrophobic surfaces, exhibited by the coating compositions prepared with the above mentioned methods and procedures, the preparation of these liquid and powder coating compositions are not difficult and cost effective. For example, such powder coatings can be realized industrially with current coating manufacturing equipment, and most importantly, they are applied with current powder application methods, such as corona or tribo charge electro-static spray.

### EXAMPLES

The invention is further described by, but not limited to, the following examples of embodiments. Although those examples are all for powder coatings, this should not be considered a limiting factor. Surfaces of finished examples were also tested using the methods described below:
a) Water contact angle test: Conducted using a Contact Angle Goniometer.
b) Test of mechanical durability of hydrophobicity: conducted using a 1 cm×1 cm 100% cotton cloth surface wrapped on a 1 cm×1 cm×1 cm cubic rubber head with 100 g normal force exerted on the coating surface while rubbing cycles are performed.
c) High pressure water test: conducted by setting a water-tap valve allowing 1 litre water flowing through per 5 seconds. Water-tap nozzle i.d. is 8 mm and the sample surface is placed 30 cm down the water-tap.

To qualify the mechanical durability of the produced hydrophobic coating, the following tests were used: wet cloth rubbing test—how many rubs the coating can sustain with a ΔCA<10° (ΔCA=change in contact angle); high pressure water test—how many seconds before a temporary failure; and the hydrophobicity recover test—whether the hydrophobicity can recover with ΔCA<5°, after the failed spot dried up at ambient environment, measured after 10 hours.

### Example 1

Production of Hydrophobic Surface with Conglomerates of Pre-Bonded Nano-Size Hydrophobic Particles

35% wt of nano-size hydrophobic particles, Aerosil® R815S is mixed with 65% wt. of a pre-made polyester TGIC (Triglycidyl Isocyanurate) clear coat powder coating (with a volume mean particle size of about 5 micrometers) in a laboratory high-shear mixer. The mixture is subsequently passed through a dual-drum press to get the mixture tightly packed in a form of brittle chips. Then the chips are heated up to about 200° C., the curing temperature of the clear coat, for 5 minutes. After the cured chips cool down, they are ground in a grinding unit to obtain the conglomerates of a volume mean size of 15 to 25 micrometers, which are composed of pre-bonded Aerosil® R815S particles and the bonding material.

Conglomerates of pre-bonded Aerosil® R815S particles prepared as described above, are dry-blended into the same powder coating, polyester TGIC clear coat, of a larger volume mean particles size, about 25 micrometers, in a laboratory high-shear mixer then screened with a 45 micron mesh sifter. This gives a prepared hydrophobic polyester TGIC powder coating. Then the prepared hydrophobic powder coating is applied to a steel test panel and cured at 200° C. for 10 minutes.

The finished surface demonstrates super-hydrophobicity with a contact angle of CA=165°. The wet cloth rubbing test showed that it survived 1200 rubs with a ΔCA<10°. The high pressure water test showed that it survived 135 seconds before a temporary failure. After, the failed spot dried up at ambient environment, and the hydrophobicity recovered with a ΔCA<5°.

### Example 2

Production of Hydrophobic Surface with Conglomerates of Pre-Bonded Nano-Sized Hydrophobic Particles

In this example, the method used was the same as described in Example 1 except that the bonding material used herein was an acrylic clear coat, different from the powder coating that the conglomerates were to be mixed in.

The finished surface demonstrates super-hydrophobicity with a contact angle of CA=162°. The wet cloth rubbing test showed that it survived 1600 rubs with a ΔCA<10°. The high pressure water test showed that it survived 195 seconds before a temporary failure. After, the failed spot dried up at ambient environment, and the hydrophobicity recovered with a ΔCA<4°.

### Example 3

Production of Hydrophobic Surface with Hydrophobic Glass Beads

Hydrophobic glass beads are prepared according to the two-step procedure described earlier. The specific ratios used in this example are:
a) the amount of the fumed silica added is 10% of the TEOS by mass;
b) the ratio of silica sol-gel to glass beads is 2 ml:1 g; and
c) the ratio of hydrophobicizing solution to glass beads is 2 ml:1 g.
   20% wt of hydrophobic glass beads were dry-blended into a black non-TGIC primid polyester powder coating of about 25 micrometers, in a laboratory high-shear mixer, then screened with a 45 micron mesh sifter. This process gave the hydrophobic primed polyester powder coating. Then this hydrophobic powder coating was applied to a steel test panel and cured at 200° C. for 10 minutes.

The finished surface demonstrated hydrophobicity with a contact angle of CA=131°. The wet cloth rubbing test showed that it survived 4200 rubs with a ΔCA<10°. The high pressure water test showed that it survived 330 seconds before a temporary failure. After 10 hours, the failed spot dried up at ambient environment, and the hydrophobicity recovered with a ΔCA<2°.

### Example 4

Production of Hydrophobic Surface with Hydrophobic Glass Beads

In this example, the method used was the same as described in Example 3 except that 1.5% wt of Aerosil® R815S was also added to the hydrophobic powder coating of Example 3 and mixed in with a laboratory high-shear mixer. The finished surface demonstrated super-hydrophobicity with a contact angle of CA=162°. The wet cloth rubbing test showed that it survived 2200 rubs with a ΔCA<10°. The high pressure water test showed that it survived 105 seconds before a temporary failure. After, the failed spot dried up at ambient environment, and the hydrophobicity recovered with a ΔCA<4°.

### Example 5

Production of Hydrophobic Surface with Conglomerates Formed by Porous Solid Particles with Incorporated Nano-Size Hydrophobic Particles

50% wt of diatomites WB-6 (Grefco Minerals, Inc.) with a volume mean particle size of 30 micrometers, is pre-mixed with 50% wt of Aerosil® R815S in a laboratory high-shear mixer to make the hydrophobic additive. The additive is then mixed into a polyester-epoxy hybrid clear coat of about 30 micrometers at a concentration of 5% wt of total, in a laboratory high-shear mixer and screened afterward through a 75 micron mesh sifter. The hydrophobic polyester-epoxy hybrid powder coating thus obtained is then applied to a steel test panel and cured at 200° C. for 10 minutes.

The finished surface demonstrated super-hydrophobicity with a contact angle of CA=162°. The wet cloth rubbing test showed that it survived 2500 rubs with a ΔCA<10°. The high pressure water test showed that it survived 115 seconds before a temporary failure. After, the failed spot dried up at ambient environment, and the hydrophobicity recovered with a ΔCA<8°.

### Example 6

Production of Hydrophobic Surface with Conglomerates Formed by Porous Solid Particles with Incorporeated Nano-Size Hydrophobic Particles

In this example, the method used was the same as described in Example 5 except that 85% wt of Zeofume Charboxite (C2C Zeolite Co.), a synthesized zeolite, with a volume mean particle size of 27 micrometers, is pre-mixed with 15% wt of Aerosil® R815S in a laboratory high-shear mixer to make the hydrophobic additive. Then, the additive is mixed into the powder coating at 17.5% of the total mass.

The finished surface demonstrated super-hydrophobicity with a contact angle of CA=160°. The wet cloth rubbing test showed that it survived 1300 rubs with a ΔCA<10°. The high pressure water test showed that it survived 130 seconds before a temporary failure. After 10 hours, the failed spot dried up at ambient environment, and the hydrophobicity recovered with a ΔCA<12°.

### Example 7

Production of Hydrophobic Surface with Hydrophobicized Porous Solid Particles

Zeofume Charboxite particles (C2C Zeolite Co.), with a volume mean particle size of 27 micrometers, are hydrophobicized with the same 2-step procedure described in Example 4, except that the ratio of silica sol-gel to zeolite is 4 ml:1 g and 15% wt of hydrophobic zeolite particles are dry-blended into the black non-TGIC primid polyester powder coating.

The finished surface demonstrated super-hydrophobicity with a contact angle of CA=159°. The wet cloth rubbing test showed that it survived 3800 rubs with a ΔCA<10°. The high pressure water test showed that it survived 110 seconds before a temporary failure. After, the failed spot dried up at ambient environment, and the hydrophobicity recovered with a ΔCA<5°.

It is noted that although the examples are all given in context of powder coating, the methods and products disclosed above can also be used for liquid coatings to form hydrophobic surfaces. Hydrophobic additives prepared with the above disclosed methods (Methods I to III) can be mixed with liquid coatings to make hydrophobic liquid coatings. The liquid coatings can be oil based or waterborne. Application methods of these hydrophobic liquid coatings are the same as those of regular liquid coatings, including brushing, spraying, dipping and rolling etc. During the drying/curing process, the organic or inorganic solvent evaporates and the cross-linking reactions occur while nano- and micro-structures are formed on the surface of the paint film. The nano- and micro-structures, together with the exposed hydrophobic surfaces of the hydrophobic additives will, similar to those with powder coatings, show hydrophobic or super-hydrophobic properties with mechanical durability.

It is noted that while the above disclosure is primarily directed to forming hydrophobic and/or olephobic coating surfaces, it will be understood by those skilled in the art that the methods disclosed herein for effectively affixing hydrophobic/olephobic nano particles onto substrate surfaces through film coating may also be used to affix other nano particles with different functions onto substrate surface for other purposes and not just being restricted to producing hydrophobic and/or olephobic surfaces.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiments illustrated. It is intended that the scope of the invention be defined by all of the embodiments encompassed within the following claims and their equivalents.

Therefore what is claimed is:

1. A method for forming a coating composition for application to a surface, comprising:
a) forming conglomerates by
providing a plurality of nano-sized particles having a mean diameter in a range from about 1 to about 500 nanometers, the nano-sized particles having hydrophobic, super-hydrophobic, olephobic, or super-olephobic properties,
mixing the plurality of nano-sized particles with a binding material to form a mixture and heating the mixture to induce curing to bind the nano-sized particles to form a consolidated cake-form material;
cooling the consolidated cake-form material and grinding the cake-form material to produce conglomerates having a size in a range from about 1 micron to about 40 microns; and
b) mixing the conglomerates with a coating material to be applied to a surface, said binding material being one of a thermosetting resin and a thermoplastic resin having a melting temperature higher than a curing temperature of the coating composition.

2. The method according to claim 1 wherein the coating material includes a solvent in which the conglomerates are mixed to form a liquid-based coating composition so that the coating composition is applied to said surface as a liquid and subsequently cured.

3. The method according to claim 1 wherein the coating material is a powder which is mixed with the conglomerates to form a powder-based coating composition.

4. The method according to claim 3 wherein the powder is also the binding material.

5. The method according to claim 1 wherein the thermosetting resin is selected from the group consisting of epoxy, polyester, epoxy-polyester hybrid, polyurethane, acrylic, and mixtures thereof.

6. The method according to claim 1 wherein the thermoplastic resin is selected from the group consisting of polyethylene, polypropylene, polychloroethene, polystyrene, acrylonitrile butadiene styrene, polyamide, polycarbonates, polyphenylene oxide, polyurethane, polytetrafluoroethylene, polybutylene terephthalate, polyethylene terephthalate, polyacrylate, polyphenylene sulfide, nylon, and mixtures thereof.

7. The method according to claim 1 wherein the nano-sized particles are selected from the group consisting of nano-size fumed particles coated with hydrophobic materials.

8. The method according to claim 1 wherein a ratio of the nano-sized particles to the binding material is in a range from about 1:5 to about 1:1.

9. The method according to claim 1 wherein a mass ratio of the conglomerates to the coating material is in a range from about 1:20 to about 1:2.

10. The method according to claim 1 wherein said coating composition includes a pre-selected amount of additional non-conglomerated nano-sized hydrophobic particles.

11. The method according to claim 1 including pressing the mixture either before or after heating to form said consolidated cake form material.

12. A coating formed using the coating composition formed by a method of claim 1, said coating produced by the steps of:
a) applying said coating composition to a surface; and
b) curing said coating composition applied to said surface, wherein some of the nano-sized particles having hydrophobic, super-hydrophobic, olephobic, or super-olephobic properties are present at a top surface of said coating to impart hydrophobic,super-hydrophobic, olephobic, or super-olephobic properties, respectively, to the top surface.
